(19) United States
(12) Patent Application Publication
(10) Pub. No.: US 2006/0131874 A1
(43) Pub. Date: Jun. 22, 2006

(54) Error proof multi-line quick connector

(76) Inventors: Lucas Frank, Farmington, MI (US); Troy Tava, St. Clair Shores, MI (US)

Correspondence Address: DAIMLERCHRYSLER INTELLECTUAL CAPITAL CORPORATION;CIMS 483-02-19, 800 CHRYSLER DR EAST, AUBURN HILLS, MI, 48326-2757, US

(21) Appl. No.: 11/020,822

(22) Filed: Dec. 22, 2004

(51) Int. Cl. F16L 5/00

(52) U.S. Cl. 285/205

(57) ABSTRACT

A retainer plate connects first and second fluid lines to spaced apart first and second ports in a manifold. The retainer plate has first and second openings spaced apart the same distance as the ports for receiving the respective first and second fluid lines. A fastener secures the retainer plate to the manifold with the first opening aligned with the first port and the second opening aligned with the second port. The fastener is eccentrically located so that it cannot be secured to the manifold with the first opening aligned with the second port and the second opening aligned with the first port, thus insuring that the two lines are not connected to the wrong ports.

### FIELD OF THE INVENTION

The present invention relates generally to connectors for fluid lines, and more particularly to a connector which insures that the fluid lines are not connected to the wrong ports.

### BACKGROUND OF THE INVENTION

There are many applications in which fluid lines deliver fluid to two separate ports. The fluid lines may, for example, transmit fluids at different pressures or they may transmit altogether different fluids. Obviously it is important that the lines be hooked up to the correct ports and not reversed. This can be done, for example, by color coding or by employing unique geometry for the couplings of the two lines. However, these expedients either require special designs or unnecessary thought processes. Special designs increase cost and color coding may simply be ignored by the installer.

### SUMMARY OF THE INVENTION

In accordance with this invention, a quick connector is provided for connecting two fluid lines to two separate ports. The quick connector comprises a retainer plate having two openings spaced apart the same distance as the ports for receiving the two lines. A first one of the openings receives one of the fluid lines and the other opening receives the other fluid line. A fastener secures the retainer plate in a position such that the openings in which the two fluid lines are received are aligned with the correct ports, and not the other way around. For that reason, the fastener is placed eccentrically with respect to the two openings in the retainer plate. More specifically, the fastener extends through a hole in the retainer plate which is offset from the midpoint of a straight line connecting the two openings in the retainer plate.

An abutment is provided near the end of each fluid line to prevent the fluid lines from pulling out of the retainer plate. In the specific embodiment about to be described, at least one of the fluid lines extends from a hose, and the retainer plate is captured on that one fluid line between the hose and the abutment. It is preferred that one of the openings in the retainer plate be in the form of a recess which is open at one side so that before the retainer plate is secured by the fastener, the retainer plate may be rotated about the fluid line in the other opening to engage the other fluid line in the recess.

In accordance with this invention, a single retainer plate secured by a single fastener is all that is required to hold both two fluid lines.

One object of this invention is to provide a quick connector having one or more of the foregoing features and capabilities.

Another object is to provide a quick connector which is composed of a few simple parts, is rugged and durable in use, and is quick and easy to install.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a top plan view of a quick connector constructed in accordance with the invention;

FIG. 2 is a sectional view taken on the line 2-2 in FIG. 1; and

FIG. 3 is a sectional view taken on the line 3-3 in FIG. 1.

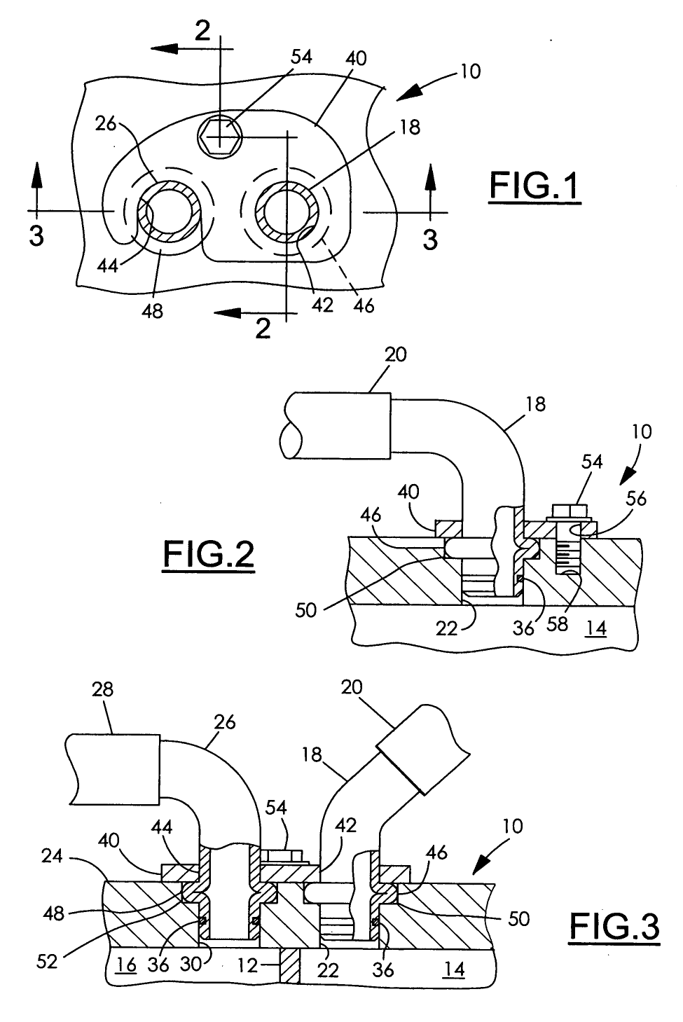

### DETAILED DESCRIPTION OF THE PREFERRED EMBODIMENT

The following description of the preferred embodiment is merely exemplary in nature and is in no way intended to limit the invention, its application, or uses.

Referring now more particularly to the drawings, a manifold 10 has a wall 12 separating chambers 14 and 16 which are adapted to receive fluid from two different sources. The chambers may, for example, lead to opposite ends of a piston-cylinder assembly of a power steering mechanism in an automotive vehicle.

The chamber 14 is adapted to receive fluid under pressure from a fluid line 18 which is an extension of a hose 20. The fluid line 18 extends through a port 22 in a wall 24 of the manifold. The chamber 16 is adapted to receive fluid under pressure from a fluid line 26 which is an extension of a hose 28. The fluid line 26 extends through a port 30 in the wall 24 of the manifold. The fluid lines 18 and 26 both have O-rings 36 which seal against the walls of ports 22 and 30.

The fluid lines are held in the ports 22 and 30 by a retainer plate 40. The retainer plate has openings 42 and 44 which are spaced apart the same distance as the manifold ports 22 and 30. The fluid line 18 extends through the opening 42 and the fluid line 26 extends through the opening 44. The opening 42 is a closed hole and the opening 44 forms a recess which is open at one side of the retainer plate 40 for a purpose which will be explained more fully hereinafter. The fluid lines 18 and 26 have enlargements 46 and 48 near their ends which form abutments that are larger than the openings 42 and 44 to prevent the fluid lines from pulling out of the retainer plate. The ports 22 and 30 are counterbored at 50 and 52 to accommodate the enlargements 46 and 48.

The retainer plate 40 is secured to the wall 24 of the manifold by a fastener in the form of a bolt 54. The bolt 54 extends through a hole 56 in the retainer plate and threads into a receiver which is in the form of a hole or socket 58 in the wall 24 of the manifold. The hole 56 in the retainer plate 40 is spaced from the midpoint of a straight line through the centers of the openings 42 and 44 in the retainer plate and thus is eccentrically located to insure that the retainer plate is secured in a position such that the opening 42 for the fluid line 18 registers with the port 22 of the manifold and the opening 44 for the fluid line 26 registers with the port 30 of the manifold, and not vice versa. If by mistake the retainer plate 40 is turned so that the opening 42 is aligned with the port 30 and the opening 44 is aligned with the port 22, the bolt hole 56 in the retainer plate will not line up with the socket 58 in the wall of the manifold and hence the retainer plate cannot be secured by the bolt 54.

It is essential that the fluid lines are in the correct holes in the retainer plate, that is, the fluid line 18 in the opening 42 and the fluid line 26 in the opening 44. This is insured due to the fact that the retainer plate is captured on the fluid line 18 between the hose 20 and the enlargement 46.

To connect the fluid lines 18 and 26 to the ports 22 and 30, the fluid line 18 is first inserted into the port 22 with the enlargement 46 in the counterbore 50. At this time, the fluid line 18 extends through the opening 42 in retainer plate 40 and the retainer plate is between the hose 20 and the enlargement 46. The fluid line 26 is inserted into the port 30 with the enlargement 48 in the counterbore 52. Then the retainer plate 40 is rotated about the fluid line 18 to cause the fluid line 26 to be extended laterally into the recess-like opening 44 in the retainer plate through the open side of the opening. The fluid lines are held in the ports 22 and 30 by the enlargements 46 and 48. Finally, the retainer plate 40 is secured to the manifold 10 by the bolt 54 which is extended through the hole 56 in the retainer plate and threaded into the socket 58 in the manifold.

This description of the invention is merely exemplary in nature and, thus, variations that do not depart from the gist of the invention are intended to be within the scope of the invention. Such variations are not to be regarded as a departure from the spirit and scope of the invention.

What is claimed is:

1. A quick connector for connecting first and second fluid lines to spaced apart first and second ports, comprising:
a retainer plate having first and second openings spaced apart the same distance as said ports for receiving the respective first and second fluid lines, and
a fastener carried by the retainer plate adapted secure the retainer plate to a fixed fastener receiver with the first opening aligned with the first port and the second opening aligned with the second port, wherein:
the fastener is offset from the midpoint of a straight line connecting the openings so that the retainer plate cannot be secured to the fastener receiver with the first opening aligned with the second port and the second opening aligned with the first port.

2. The quick connector of claim 1, wherein the fastener comprises a bolt which extends through a hole in the retainer plate in a position offset from the midpoint of the straight line connecting the openings in the retainer plate, and the receiver comprises a threaded socket for threadedly receiving the bolt.

3. The quick connector of claim 1, wherein each of the fluid lines has an abutment for preventing the fluid lines from pulling out of the openings in the retainer plate.

4. The quick connector of claim 1, wherein the first opening is closed and the second opening comprises a recess which is open at one side of the retainer plate so that before the retainer plate is secured by the fastener the first fluid line may be received in the first opening and the retainer plate may then be rotated about the first fluid line to cause the second fluid line to be received in the recess.

5. The quick claim connector of claim 1, wherein the first line extends from a hose for supplying fluid to the first line, and the retainer plate is captured between the hose and the abutment on the first line to prevent the retainer plate from separating from the first line.

6. The quick connector of claim 1, wherein the fastener comprises a bolt which extends through a hole in the retainer plate in a position offset from the midpoint of the straight line connecting the openings in the retainer plate, and the receiver comprises a threaded socket for threadedly receiving the bolt,
wherein each of the fluid lines has an abutment for preventing the fluid lines from pulling out of the openings in the retainer plate, and
wherein the first opening is closed and the second opening comprises a recess which is open at one side of the retainer plate so that before the retainer plate is secured by the bolt the first fluid line may be received in the first opening and the retainer plate may then be rotated about the first fluid line to cause the second fluid line to be received in the recess.

7. The quick connector of claim 6, wherein the first line extends from a hose for supplying fluid to the first line, and the retainer plate is captured between the hose and the abutment on the first line to prevent the retainer plate from separating from the first line.
